(19) United States
(12) Patent Application Publication
(10) Pub. No.: US 2025/0045228 A1
(43) Pub. Date: Feb. 6, 2025

(54) INFORMATION PROCESSING APPARATUS

(71) Applicant: Lenovo (Singapore) Pte. Ltd., Singapore (SG)

(72) Inventor: Keisuke Shimizu, Kanagawa (JP)

(73) Assignee: Lenovo (Singapore) Pte. Ltd., Singapore (SG)

(21) Appl. No.: 18/778,886

(22) Filed: Jul. 19, 2024

(30) Foreign Application Priority Data
Aug. 1, 2023 (JP) 2023-125481

(51) Int. Cl. G06F 13/38; G06F 1/26

(52) U.S. Cl. CPC G06F 13/385; G06F 1/266; G06F 2213/3854

(57) ABSTRACT

An information processing apparatus includes: a host system; a rectifying element configured to output a signal input to one end to the other end; and a socket configured to connect a peripheral device. The host system is connected to the other end, the socket includes a first signal terminal to which a first signal is input from the peripheral device and a second signal terminal to which a second signal is input from the peripheral device in a case where the socket is connected to the peripheral device, and the first signal terminal is connected to the one end, the first signal has a first voltage higher than a reference potential, the second signal has a second voltage higher than the reference potential in a case where the first voltage is equal to or lower than an operation voltage of the host system.

### CROSS-REFERENCE TO RELATED APPLICATIONS

This application claims priority to Japanese Patent Application No. 2023-125481 filed on Aug. 1, 2023, the contents of which are hereby incorporated herein by reference in their entirety.

### TECHNICAL FIELD

The present disclosure relates to output control of a sideband signal from an information processing apparatus, for example, a solid state drive.

### BACKGROUND

The functions of information processing apparatuses, such as personal computers (PCs), are expanded by adding various devices. Typically, the information processing apparatuses include a storage device. Examples of the auxiliary storage device include a solid state drive (SSD). A host system, which is a core of each information processing apparatus, detects a device provided in the host system and controls the operation of the detected device. An individual device outputs an output signal for notifying the host system of information such as the presence, the specification, the operating state, and the operating environment of the device in accordance with a predetermined input/output method. For example, Japanese Unexamined Patent Application Publication No. 2019-028934 describes an information processing apparatus that includes a storage device and that enables the control of the storage device by a host system in accordance with a predetermined internal bus interface standard.

A voltage higher than a reference voltage may be applied to an output signal of an individual device (pull-up). The applied voltage may be equal to an operation voltage of a device of an output source. Meanwhile, the operation voltages of the host system and each device may vary individually. In a case where the operation voltage of the device is higher than the operation voltage of the host system, the voltage of the output signal is also higher than the operation voltage of the host system. Therefore, there is a concern that an obstacle or a failure may occur in the host system. For that reason, a device having the same operation voltage as the operation voltage of the host system may be adopted.

However, a processor constituting the host system may fix the operation voltage to a certain value. Also, the information processing apparatus includes a socket that enables attachment and detachment of some devices including SSDs, and may be mounted with a device having an operation voltage higher than the operation voltage of the host system. In that case, an output signal having a voltage higher than the operation voltage of the host system may be input from the device mounted on the host system. For example, in a case where an SSD having an operation voltage of 3.3 V is connected to a CPU having an operation voltage capable of being switched between 1.8 V and 3.3 V, even in a case where the SSD is replaced with an SSD having an operation voltage of 1.8 V, a signal having a voltage higher than the operation voltage is not input to the CPU from the replaced SSD. Meanwhile, in a case where an SSD having an operation voltage of 3.3 V is connected to the CPU having an operation voltage fixed to 1.8 V, there is a possibility that a signal having a voltage higher than the operation voltage is input to the CPU.

### SUMMARY

An information processing apparatus according to one or more embodiments of the present application includes a host system; a rectifying element configured to output a signal input to one end to the other end; and a socket configured to connect a peripheral device. The host system is connected to the other end. The socket includes a first signal terminal to which a first signal is input from the peripheral device and a second signal terminal to which a second signal is input from the peripheral device in a case where the socket is connected to the peripheral device, and the first signal terminal is connected to the one end. The first signal has a first voltage higher than a reference potential. The second signal has a second voltage higher than the reference potential in a case where the first voltage is equal to or lower than an operation voltage of the host system, and has a second voltage having no significant difference from the reference potential in a case where the first voltage is higher than the operation voltage of the host system. The information processing apparatus further includes a circuit configuration configured to bring a potential of the one end close to the reference potential in a case where the first voltage is higher than the operation voltage of the host system.

In the information processing apparatus, in the circuit configuration, the second signal terminal may be short-circuited to the first signal terminal.

The information processing apparatus may further include a power supply circuit configured to supply power to the peripheral device in a case where an operation control signal having a voltage higher than the reference potential is input; and a power switch configured to output an operation instruction signal indicating necessity of an operation of the information processing apparatus in accordance with whether or not the operation control signal has a voltage higher than the reference potential. The circuit configuration includes a logical product circuit that outputs, to the power supply circuit, an operation control signal having a voltage higher than the reference potential in a case where a voltage of the operation instruction signal and the second voltage are each higher than the reference potential, and having a voltage having no significant difference from the reference potential in a case where at least one of the voltage of the operation instruction signal and the second voltage has no significant difference from the reference potential.

In the information processing apparatus, the peripheral device may be a solid state drive.

In the information processing apparatus, the second voltage higher than the first voltage and the reference potential may be each equal to an operation voltage of the peripheral device.

In the information processing apparatus, the first signal may be a sideband signal indicating an operation situation of the peripheral device, and the second signal may be a voltage setting signal indicating an operation voltage of the peripheral device.

In the information processing apparatus, the sideband signal may be a power loss notification signal indicating whether or not power loss of the peripheral device occurs, and the voltage setting signal may indicate whether or not the operation voltage of the peripheral device is equal to the operation voltage of the host system.

According to one or more embodiments of the present application, the input of a signal having a voltage higher than the operation voltage to the host system is avoided.

### BRIEF DESCRIPTION OF THE DRAWINGS

FIG. 1 is a schematic block diagram illustrating a hardware configuration example of an information processing apparatus according to one or more embodiments.

FIG. 2 is a schematic block diagram illustrating an example of a circuit configuration of the information processing apparatus according to one or more embodiments.

FIG. 3 is a schematic block diagram illustrating a first example of a use state of the information processing apparatus according to one or more embodiments.

FIG. 4 is a schematic block diagram illustrating a second example of the use state of the information processing apparatus according to one or more embodiments.

FIG. 5 is a schematic block diagram illustrating another example of the circuit configuration of the information processing apparatus according to one or more embodiments.

FIG. 6 is a schematic block diagram illustrating a third example of the use state of the information processing apparatus according to one or more embodiments.

FIG. 7 is a schematic block diagram illustrating a fourth example of the use state of the information processing apparatus according to one or more embodiments.

### DETAILED DESCRIPTION

Hereinafter, embodiments of the present application will be described with reference to the drawings. First, an outline of an information processing apparatus 1 according to one or more embodiments will be described.

The information processing apparatus 1 includes a host system, a rectifying element that outputs a signal input to one end to the other end, and a socket that enables the connection of a peripheral device. The information processing apparatus 1 is, for example, a personal computer (PC). The information processing apparatus 1 may have any form such as a clamshell PC or a desktop PC. The information processing apparatus 1 may be realized as any type of electronic apparatus such as a tablet terminal apparatus or a mobile phone.

The host system of the information processing apparatus 1 is connected to the other end of the rectifying element, and the socket includes at least a first signal terminal and a second signal terminal. In a case where the socket is connected to the peripheral device, a first signal is input to the first signal terminal from the peripheral device, and a second signal is input to the second signal terminal. The first signal has a first voltage higher than a reference voltage, the second signal has a second voltage equal to or higher than the reference voltage in a case where the first voltage is equal to or lower than an operation voltage of the host system, and the second signal has the second voltage equal to the reference voltage in a case where the first voltage is equal to or higher than the operation voltage of the host system. The information processing apparatus 1 has a circuit configuration that brings one end voltage close to the reference voltage in a case where the first voltage is equal to or higher than the operation voltage of the host system.

Next, a hardware configuration example of the information processing apparatus 1 according to one or more embodiments will be described.

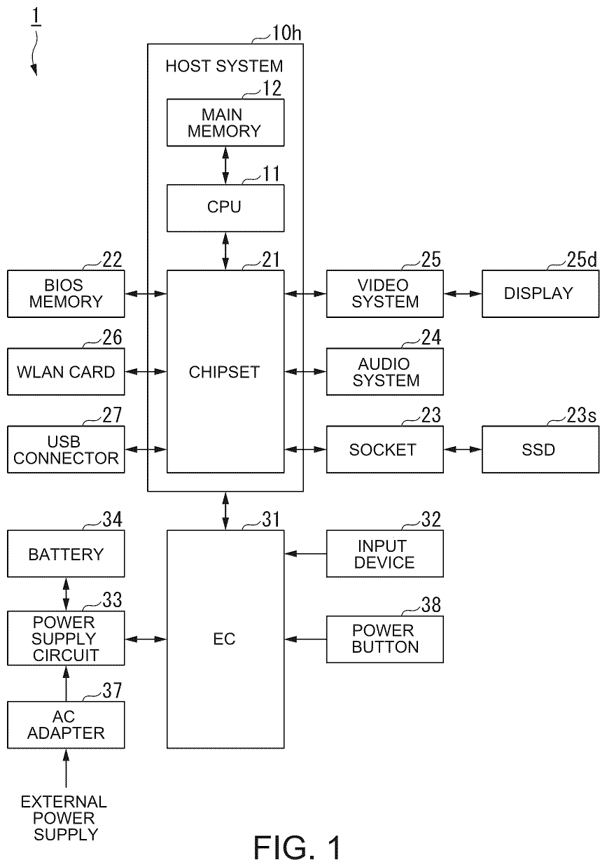

FIG. 1 is a schematic block diagram illustrating the hardware configuration example of the information processing apparatus 1 according to one or more embodiments. The information processing apparatus 1 includes a CPU 11, a main memory 12, a chipset 21, a basic input output system (BIOS) memory 22, a socket 23, an audio system 24, a video system 25, a wireless local area network (WLAN) card 26, a universal serial bus (USB) connector 27, an embedded controller (EC) 31, an input device 32, a power supply circuit 33, a battery 34, an alternating current (AC) adapter 37, and a power button 38.

The CPU 11 is a processor that is a core of a system device provided in the information processing apparatus 1. The CPU 11 is a processor that enables the execution of various arithmetic processing instructed by commands written in various programs. The CPU 11 executes processing instructed by various programs, such as an operating system (OS), BIOS, firmware, and an application program (referred to as an “app” in the present application).

The CPU 11 executes an OS to provide functions, such as resource management, execution management of various programs, input/output control, and file management in the computer system that is a core of the information processing apparatus 1, that is, the host system. Executing the processing instructed by a command written in a program may be referred to as “execution of the program” or “executing the program”.

The main memory 12 is a writable memory used as a read area for an execution program of the CPU 11 or as a work area for writing the processing data of the execution program. The main memory 12 is configured by, for example, a plurality of dynamic random access memory (DRAM) chips. The execution program includes the OS, various drivers for operating hardware such as peripheral devices, various services/utilities, apps, and the like.

The chipset 21 includes one or a plurality of bus controllers and enables connection to a plurality of peripheral devices to allow various kinds of data to be input and output. The bus controller may be, for example, any one of a USB, a serial advanced technology attachment (ATA), a serial peripheral interface (SPI) bus, a peripheral component interconnect (PCI) bus, a PCI-Express bus, a low pin count (LPC), and the like, or a combination of any one thereof. For example, the BIOS memory 22, an SSD 23s, the audio system 24, the video system 25, the WLAN card 26, and the EC 31 correspond to the plurality of peripheral devices as connection destinations.

The CPU 11, the main memory 12, and the chipset 21 correspond to system devices constituting the host system 10h. The host system 10h functions as a computer system that is a core of the information processing apparatus 1. The host system 10h is configured to include a system device as hardware, and software such as an OS and a schedule task.

The BIOS memory 22 stores firmware or the like for controlling the operation of the SSD 23s, the audio system 24, the video system 25, the WLAN card 26, the EC 31, and other peripheral devices, in addition to the BIOS. The BIOS is firmware for performing basic input and output of a system device. In the present application, the BIOS may also refer to firmware defined in accordance with a specification specified in Unified Extensible Firmware Interface (UEFI). The BIOS memory 22 is configured to include an electrically rewritable nonvolatile memory. As such a nonvolatile memory, for example, an electrically erasable programmable read only memory (EEPROM), a flash read only memory (ROM), or the like is available.

The socket 23 is configured in accordance with a predetermined standard, and is a connector for connecting various peripheral devices by wire. The socket 23 includes a plurality of terminals and, and enables the input and output of various signals between the peripheral devices that are fitted into and connected to the terminals. The socket 23 is, for example, an M.2 socket configured in accordance with an M.2 standard. In the example in FIG. 1, the socket 23 is connected to the SSD 23s.

The solid state drive (SSD) 23s is an example of a peripheral device connected to the chipset 21 by using the socket 23. The SSD 23s is an example of an auxiliary storage device that continuously and readably/writably stores various kinds of data. The data to be stored includes various programs that may be executed by the CPU 11, parameters, data used for various types of processing, and data acquired by the various types of processing. The SSD 23s includes various nonvolatile memories. For example, a flash memory is used as the nonvolatile memory. The various programs may include, for example, any one of an OS, a driver, firmware, an app, and the like, or a combination of any one thereof.

The audio system 24 is connected to a microphone (not illustrated) and a speaker (not illustrated), and enables the execution of recording, reproducing, and outputting of voice data. The microphone and the speaker may be built, for example, in the information processing apparatus 1 or may be separate from the information processing apparatus 1.

The video system 25 processes a drawing command input from the CPU 11 and writes drawing information obtained by the processing into a video memory (not illustrated). The video system 25 reads out the drawing information from the video memory and configures a display screen including the read-out drawing information (image processing). The video system 25 outputs display data indicating the display screen to a display 25d.

The display 25d displays a display screen based on the display data input from the video system 25. For example, the display 25d may be any one of such as a liquid crystal display (LCD), an organic light emitting diode (OLED) display, and the like.

The wideband local area network (WLAN) card 26 is connected to a wireless LAN or another apparatus via the wireless LAN, and enables the transmission and reception of various kinds of data between a connection destination and the apparatus.

The USB connector 27 is a separate connector for connecting various peripheral devices to the socket 23 by wire. The USB 27 uses a USB method as an input/output method with the connected peripheral device.

The EC 31 is a one-chip microcomputer that monitors and controls the situations of various devices (peripheral devices, sensors, and the like) regardless of the operation state of the host system 10h. The EC 31 includes a ROM, a plurality of channels of analog-to-digital (A/D) input terminals, a digital-to-analog (D/A) output terminal, a timer, and an input/output interface (not illustrated), in addition to a processor that is separate from the CPU 11 and the RAM that is separate from the main memory 12. The EC 31 executes predetermined firmware to exhibit the function of the firmware.

Devices such as the input device 32, the power supply circuit 33, and the power button 38 are connected to the input/output interface of the EC 31 by wire. The EC 31 enables the control of the operation of the devices. The input/output interface may be connected to various devices such that data is capable of being transmitted and received wirelessly. The input device 32 may be connected to the EC 31 wirelessly. The input device 32 may realize wireless connection using, for example, a short-range wireless communication method specified in IEEE 802.15.1. A device that is used regardless of the operation situation of the host system 10h or a device having a lower data transmission rate than the chipset 21 is connected to the EC 31.

The input device 32 detects a user's operation and outputs an operation signal generated in response to the detected operation to the EC 31. For example, a keyboard and a touch pad correspond to the input device 32. The input device 32 may further include a touch sensor. The touch sensor may overlap the display 25d and may be configured as a touch panel.

The power supply circuit 33 supplies power required for the operation of each device provided in the information processing apparatus 1 in accordance with the control of the EC 31. The power supply circuit 33 may supply power required for the operation of a peripheral device connected to the information processing apparatus 1 by wire. An operation voltage of the device may vary for an individual device. The various devices may also include a device that requires a plurality of levels of voltages. The plurality of levels of voltages may include a reference voltage in addition to the operation voltage.

The power supply circuit 33 includes a converter that converts a voltage of the power supplied to the power supply circuit 33 and a power feeder that feeds, to the battery 34, the power of which the voltage is converted. In a case where direct-current power is supplied from the alternating current (AC) adapter 37, the power feeder supplies the power remaining without being consumed in each device to the battery 34. In a case where power is not supplied from the AC adapter 37 or in a case where the power supplied from the AC adapter 37 is insufficient for the power consumption consumed by each device, the power discharged from the battery 34 is supplied to each device as the operation power.

As the converter, for example, one or a plurality of direct current/direct current (DC/DC) converters are used. The plurality of DC/DC converters may be used for each converted voltage. For example, some DC/DC converters may be connected to devices of which the operation states may vary in response to a system device or an operation mode of the system device. The power supplied to some DC/DC converters may be controlled on the basis of the operation mode notified from the EC 31. The other DC/DC converters may be connected to devices that operate regardless of the operation mode of the system device. The other DC/DC converters enable a regular supply of constant power.

The DC/DC converters may be separately used as power supplies for supplying power to individual devices, for example. In the following description, power supplies that supply power to peripheral devices may be referred to as “peripheral device power supplies”. Among the peripheral device power supplies, a power supply that supplies power to the SSD 23s may be referred to as an “SSD power supply”.

The power consumption of the host system 10h may occupy most of the power consumption of the information processing apparatus 1. The power consumption of the host system 10h significantly varies depending on the operation mode. The operation mode includes at least a standard mode and a power-saving mode. The standard mode is a standard operation mode in which the power consumption of the CPU 11 is standard. The power-saving mode is an operation mode in which power consumption is smaller than the power consumption in the standard mode. In the power-saving mode, the operation of some peripheral devices is stopped. In the power-saving mode, a peripheral device of which the operation is stopped includes, for example, the display 25d.

The power button 38 receives the pressing to the power button 38 and outputs a signal indicating the necessity of the operation of the information processing apparatus 1 to the EC 31 as an operation instruction signal. The power button 38 switches the necessity (Power ON/OFF) of the operation each time the pressing is detected. The EC 31 controls the necessity of supply of power to each device by the power supply circuit 33 on the basis of the operation instruction signal input from the power button 38. The operation instruction signal is, for example, a binary signal having any one of a significantly higher voltage (H: High) than the reference potential or a lower voltage (L: Low) having no significant difference from the reference potential. In the present application, the term “significantly higher”, “significantly lower”, or “significant difference” means having a substantial difference, for example, being greater than an error or noise.

In a case where the host system 10h is not operating and the operation instruction signal indicating an operation request is acquired, the EC 31 causes the power supply circuit 33 to start supplying power to the host system 10h. The host system 10h executes startup processing in accordance with the above firmware.

The battery 34 stores the power supplied from the power supply circuit 33 on the basis of the control of the power supply circuit 33. The battery 34 discharges a part of the stored power to the power supply circuit 33. A secondary battery is used as the battery 34. The secondary battery is a storage battery capable of both charging and discharging. The secondary battery is, for example, a lithium ion battery.

The AC adapter 37 converts the alternating-current power supplied from an external power supply into direct-current power having a constant voltage and supplies the converted power to the power supply circuit 33. The AC adapter 37 includes a mounting tool that enables attachment to and detachment from a chassis of the information processing apparatus 1 including the power supply circuit 33. The mounting tool includes an interface capable of transmitting both power and data in accordance with a predetermined standard. As the predetermined standard, it is possible to use, for example, USB Type-C.

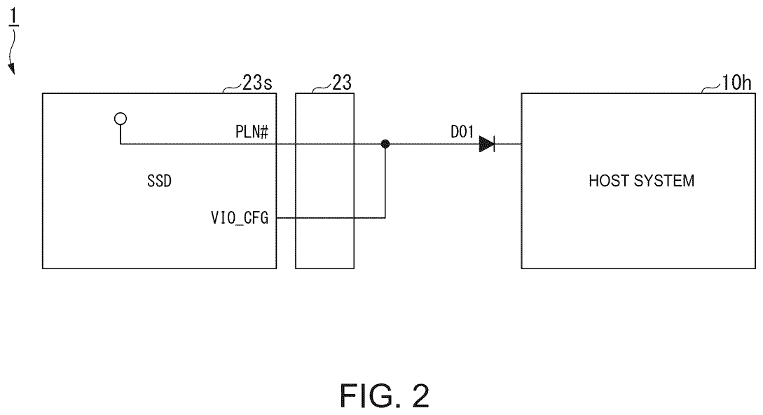

Next, examples of a circuit configuration according to one or more embodiments will be described with reference to FIGS. 2 to 4. In the examples of FIGS. 2 to 4, a case where the SSD 23s is connected to the socket 23 is assumed. The SSD 23s corresponds to an example of a peripheral device. The socket 23 includes a plurality of terminals. An individual terminal is electrically connected to the chipset 21 (FIG. 1) to enable input and output of various electric signals. As described above, the chipset 21 is a constituent member of the host system 10h. The information processing apparatus 1 includes a rectifying element D01. The rectifying element D01 includes, for example, a diode. One terminal (hereinafter, referred to as a “first signal terminal” in the present application) among the plurality of terminals provided in the socket 23 is connected via the chipset 21 and the rectifying element D01. The rectifying element D01 passes an input signal input to one end of the rectifying element D01 and outputs the input signal from the other end of the rectifying element D01, and blocks a signal input to the other end and does not output the signal to the one end. The other one terminal (hereinafter, may be referred to as a “second signal terminal” in the present application) of the socket 23 is electrically short-circuited to the first signal terminal. The second signal terminal is also electrically connected to one end of the rectifying element D01.

The first signal and the second signal are input from the SSD 23s to the first signal terminal and the second signal terminal, respectively, in a state in which the SSD 23s in operation are connected to the socket 23. An electric signal having a voltage (hereinafter, may be referred to as a “first voltage” in the present application) significantly higher than the reference potential of the information processing apparatus 1 may be input as the first signal.

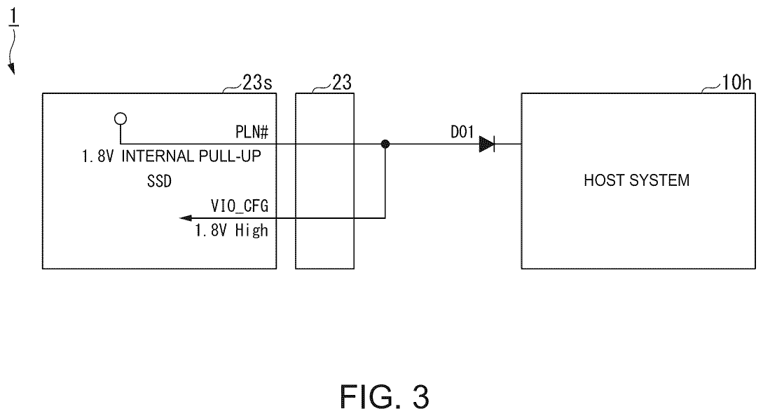

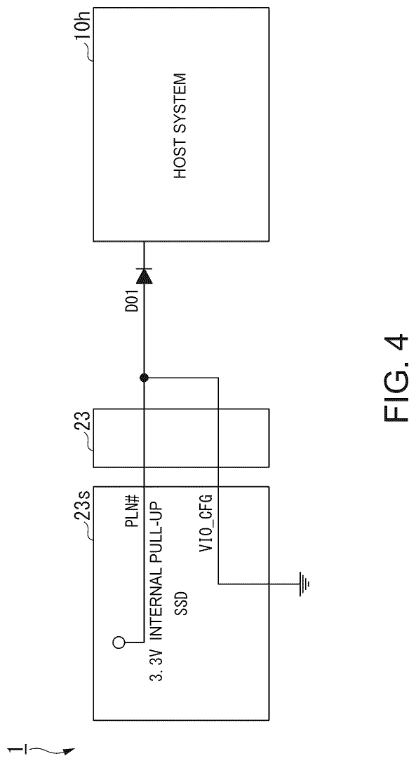

In the examples of FIGS. 2 to 4, a power loss notification signal (PLN #) is applied as the first signal. The power loss notification signal is an example of a sideband signal indicating an operation situation of the SSD 23s. The power loss notification signal is a binary signal having a high voltage having a significant difference from the reference potential in a case where power is normally supplied to the SSD 23s, and having a low voltage having no significant difference from the reference potential in a case where power is not normally supplied to the SSD 23s. The first voltage is 1.8 V in the example of FIG. 3 and is 3.3 V in the example of FIG. 4. In these examples, the first voltage is pulled up inside the SSD 23s to be equal to the operation voltage of the SSD 23s.

A signal having a voltage equal to or higher than the reference potential of the information processing apparatus 1 in a case where the first voltage is equal to or lower than the operation voltage of the host system 10h and having a voltage having no significant difference from the reference potential in a case where the first voltage is higher than the operation voltage of the host system 10h is input as the second signal. In the present application, the voltage of the second signal may be referred to as a “second voltage”. In the examples of FIGS. 2 to 4, a voltage setting signal (vio_cfg, I/O voltage configuration) is applied as the second signal. The voltage setting signal is a signal indicating an operation voltage of the SSD 23s by the voltage of the voltage setting signal. In the example of FIG. 3, the second voltage is 1.8 V. The second voltage is equal to the operation voltage of the SSD 23s and the first voltage during the operation of the SSD 23s. In contrast, in the example in FIG. 4, the second voltage is 0 V, which is equal to the reference potential. In this case, an output terminal of the second signal of the SSD 23s is connected to a reference point (GND) of the potential. The potential at the reference point corresponds to the reference potential. Therefore, the voltage setting signal may also be regarded as a binary signal indicating whether or not the operation voltage of the SSD 23s is equal to the operation voltage of the host system 10h.

The information processing apparatus 1 exemplified in FIGS. 2 to 4 has a configuration in which the potential of the first signal terminal is brought close to the reference potential in a case where the first voltage is higher than the operation voltage of the host system 10h. More specifically, the second signal terminal is short-circuited to the first signal terminal. As exemplified in FIG. 3, a case where the SSD 23s having an operation voltage of 1.8 V is connected to the socket 23 is assumed. In this case, a first signal in which the first voltage is 1.8 V and a second signal in which the second voltage is 1.8 V are input to the socket 23. The potential at one end of the rectifying element D01 is 1.8 V. This potential is equal to 1.8 V, which is the operation voltage of the host system 10h. In addition, in a case where the supply of power to the SSD 23s is stopped, each of the first voltage and the second voltage is equal to the reference voltage. For that reason, a signal having a voltage higher than the operation voltage of the host system 10h is not input to the host system 10h.

Meanwhile, as exemplified in FIG. 4, a case where the SSD 23s having an operation voltage of 3.3 V is connected is assumed. In this case, a first signal in which the first voltage is 3.3 V and a second signal in which the second voltage is 0 V are input to the socket 23. In the SSD 23s, the output terminal of the second signal is connected to the reference point, and the second output terminal and the first output terminal are short-circuited. Therefore, the potential of one end of the rectifying element D01 is 0 V. For that reason, the first signal having a voltage exceeding the operation voltage of 1.8 V is not input to the host system 10h.

In this case, the host system 10h may recognize that the supply of power to the SSD 23s is stopped and may not perform input to and output from the SSD 23s. Originally, the SSD 23s having an operation voltage higher than the operation voltage of the host system 10h should not be connected to the socket 23. For that reason, the host system 10h does not particularly have a problem even in a case where input to and output from the SSD 23s are not performed. In addition, since the backflow of the current from the other end to one end of the rectifying element D01 is prevented, the operation voltage of the host system 10h is maintained at 1.8 V.

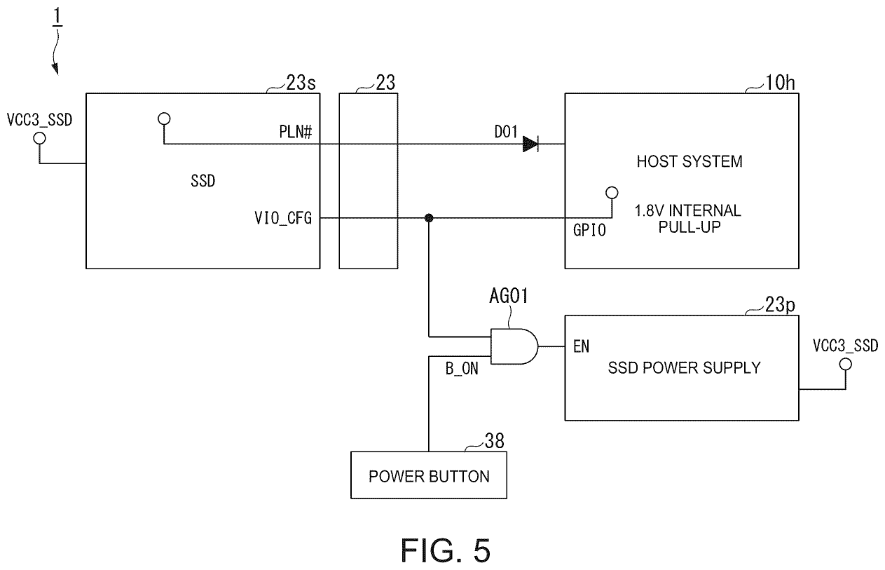

Next, other examples of the circuit configuration according to one or more embodiments will be described with reference to FIGS. 5 to 7. In the following description, the differences from the examples of FIGS. 2 to 4 will be mainly described, and the description of FIGS. 2 to 4 will be referred to unless otherwise specified. The information processing apparatus 1 exemplified in FIGS. 5 to 7 includes the host system 10h, the socket 23, an SSD power supply 23p, and a logical product circuit AG01. Even in the examples of FIGS. 5 to 7, the first signal terminal is connected to the host system 10h via the rectifying element D01 by using a first signal line. In contrast, the second signal terminal is connected to the host system 10h in parallel with the first signal line by using a second signal line. The second signal terminal is insulated without being short-circuited to the first signal terminal. The other end of the second signal line is connected to a general purpose input/output (GPIO) interface provided in the host system 10h. The GPIO interface is a general terminal provided in an integrated circuit, a computer board, or the like. A voltage significantly higher than the reference potential is applied (pulled up) to the GPIO interface. In the examples of FIGS. 5 to 7, the voltage applied to the GPIO interface is 1.8 V corresponding to the operation voltage of the host system 10h.

The logical product circuit AG01 includes two input terminals and one output terminal, and computes a logical product of a first logical value indicated by a first binary signal input to one input terminal (hereinafter, referred to as a “first input terminal” in the present application) and a second logical value indicated by a second binary signal input to the other input terminal (hereinafter, referred to as a “second input terminal” in the present application). The logical product circuit AG01 is also referred to as an AND circuit or an AND gate. The logical product circuit AG01 outputs an output signal indicating the obtained logical product from the output terminal.

In the examples of FIGS. 5 to 7, the second signal is input as the first binary signal. The second signal line is branched between the socket 23 and the host system 10h and is connected to the first input terminal of the logical product circuit AG01. The second signal is a binary signal having a high voltage (1.8 V in the examples of FIGS. 5 to 7) higher than the reference potential in a case where the operation voltage of the SSD 23s is equal to or lower than the operation voltage of the host system 10h, and having a low voltage having no significant difference from the reference potential in a case where the operation voltage of the SSD 23s exceeds the operation voltage of the host system 10h. An operation instruction signal (B_ON) is input from the power button 38 to the second input terminal as the second binary signal. An output signal having a high voltage significantly higher than the reference potential or having a low voltage having no significant difference from the reference potential is output to the SSD power supply 23p from the output terminal of the logical product circuit AG01 as the logical product of the first logical value and the second logical value.

The SSD power supply 23p is a power supply circuit that enables the supply of the power required for the operation of the SSD 23s. The SSD power supply 23p includes a control terminal EN, and is an output signal, which is output from the logical product circuit AG01, is input to the control terminal EN as an operation control signal for the SSD 23s. The control terminal EN may be referred to as an enable terminal, and the operation control signal may be referred to as an enable signal.

The SSD power supply 23p supplies power having a predetermined operation voltage VCC3_SSD to the SSD 23s (SSD power on) in a case where an operation control signal having a significantly higher voltage than the reference potential is input to the SSD 23s. In this case, the SSD 23s is operated by consuming the power supplied from the SSD power supply 23p. The SSD 23s that is operating applies a predetermined first voltage to the output terminal of the first signal (pull-up), and outputs the first signal having the first voltage as a signal voltage to the first signal terminal.

The SSD 23s in which the operation voltage is equal to or lower than the operation voltage of the host system 10h applies (pulls up) a predetermined second voltage significantly higher than the reference voltage to the output terminal of the second signal and outputs the second signal having the second voltage to the second signal terminal. Since the second voltage is equal to or lower than the operation voltage of the host system 10h, the second signal having a voltage higher than the operation voltage of the host system 10h is not input to the host system 10h.

The SSD 23s having an operation voltage higher than the operation voltage of the host system 10h outputs the second signal having the second voltage having no significant difference from the reference voltage to the second output terminal even in a case where the SSD 23s is operated. Since the second voltage is lower than the operation voltage of the host system 10h, the second signal having a voltage higher than the operation voltage of the host system 10h is not input to the host system 10h.

The SSD power supply 23p does not supply power to the SSD 23s (SSD power off) in a case where an operation control signal having a low voltage having no significant difference from the reference potential is input. Since power is not supplied from the SSD power supply 23p, the SSD 23s is not operated. For that reason, the first signal having the predetermined first voltage is not output from the first signal terminal of the SSD 23s. In addition, as long as the SSD 23s is not operated, the second signal having a voltage higher than the operation voltage of the host system 10h is not input to the host system 10h.

In this way, in the examples in FIGS. 5 to 7, the logical product circuit AG01 to which the operation signal and the second signal are input is provided. The logical product circuit AG01 outputs, to the SSD power supply 23p, an operation control signal having a high voltage significantly higher than the reference potential in a case where the voltage of the operation signal and the second voltage are each significantly higher than the reference potential, and having a low voltage having no significant difference from the reference potential in any of the voltage of the operation signal and the second voltage. The SSD power supply 23p is capable of controlling the necessity of supply of power to the SSD 23s in accordance with whether or not the voltage of the operation control signal is significantly higher than the reference potential.

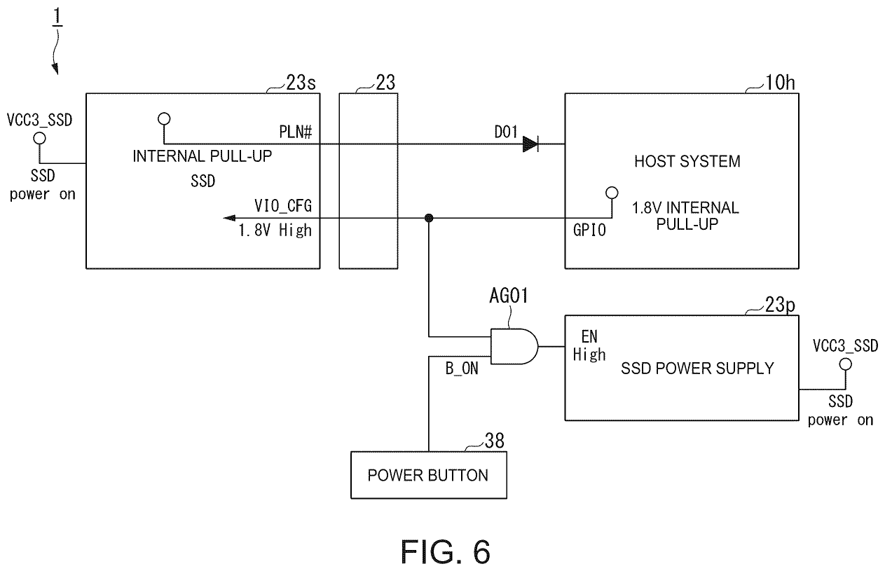

As exemplified in FIG. 6, a case where the SSD 23s having an operation voltage of 1.8 V is connected to the socket 23 is assumed. In this case, a first signal in which the first voltage is 1.8 V and a second signal in which the second voltage is 1.8 V are input to the socket 23 by the internal pull-up in the SSD 23s. The potential at one end of the rectifying element D01 is 1.8 V. The potential at the first input terminal of the logical product circuit AG01 is significantly higher than 1.8 V and the reference potential. Since the operation instruction signal having a high voltage significantly higher than the reference potential is input from the power button 38, the logical product circuit AG01 outputs the operation control signal having a high voltage significantly higher than the reference potential to the SSD power supply 23p. The SSD power supply 23p supplies power to the SSD 23s in response to the operation control signal having a significantly higher voltage than the reference potential being input to the logical product circuit AG01. In this case, the potential at the second signal terminal is also 1.8 V. Thus, the first signal and the second signal having a voltage exceeding the operation voltage of 1.8 V are not input to the host system 10h.

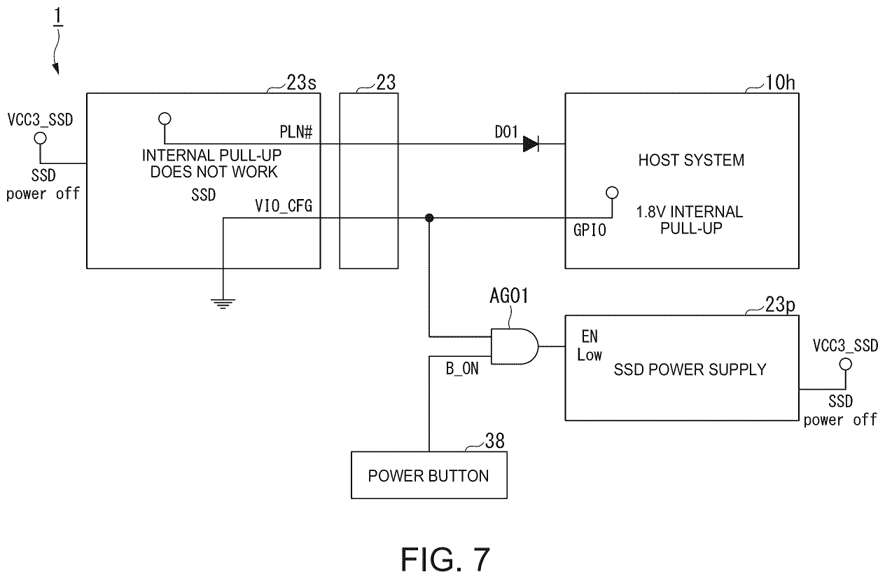

Next, as exemplified in FIG. 7, a case where the SSD 23s having an operation voltage of 3.3 V is connected is assumed. Even in a case where the SSD 23s has been operated, the first signal having a first voltage of 3.3 V may be input to the socket 23. The potential at the first input terminal of the logical product circuit AG01 is equal to 0 V and the reference potential. Even in a case where the operation instruction signal having a high voltage significantly higher than the reference potential is input from the power button 38, the logical product circuit AG01 outputs the operation control signal having a low voltage having no significant difference from the reference potential to the SSD power supply 23p. Since the operation control signal having a significantly higher voltage than the reference potential is not input to the logical product circuit AG01, the SSD power supply 23p does not supply power to the SSD 23s. In this case, since the SSD 23s is not operated, the internal pull-up in the SSD 23s does not function. For that reason, the first signal having the operation voltage of 3.3 V is not input to the first signal terminal. In addition, even in a case in which the SSD 23s is operated, the second voltage of the second signal output from the second signal terminal is 0 V. Thus, the first signal and the second signal exceeding the operation voltage of 1.8 V are not input to the host system 10h.

The SSD power supply 23p may be configured as a part of the power supply circuit 33 or may be configured as a part of the SSD 23s.

As the first signal, a different type of electric signal from the power loss notification signal PLN #, for example, any sideband signal, such as a clock request signal CLKREQ #, a reset signal PERST #, or a startup signal WAKE #, may be used. As the first signal, other electric signals having a first voltage significantly higher than the reference potential during the normal operation of the SSD 23s may be used.

Another type of electric signal having a second voltage having significantly higher than the reference potential in a case where the first voltage is equal to or lower than the operation voltage of the host system 10h, and having a second voltage having no significant difference from the reference potential in a case where the first voltage is higher than the operation voltage of the host system 10h may be used as a different type of electric signal from the voltage setting signal vio_cfg as the second signal.

In addition, the peripheral device is not limited to the SSD 23s. The peripheral device may be another type of device that enables the output of electric signals having the same characteristics as the first signal and the second signal to each of the first signal terminal and the second signal terminal and that enables attachment to and detachment from the socket 23 by applying an external force to the socket 23. The other types of devices may be, for example, a hard disk drive (HDD), a network interface card, an input/output interface card, a video module, an audio module, and the like.

The rectifying element D01 is not limited to the diode and may be a thyristor, a metal-oxide-semiconductor field-effect transistor (MOSFET), or the like.

As described above, the information processing apparatus 1 according to one or more embodiments includes the host system 10h, the rectifying element D01 that outputs a signal input to one end to the other end, and the socket 23 that enables the connection of the peripheral device. The host system 10h is connected to the other end of the rectifying element D01, and the socket 23 includes the first signal terminal to which the first signal is input from a peripheral device and the second signal terminal to which the second signal is input from the peripheral device, in a case where the socket 23 is connected to the peripheral device. The first signal terminal is connected to one end of the rectifying element D01. The first signal has the first voltage higher than the reference potential, the second signal has the second voltage higher than the reference potential in a case where the first voltage is equal to or lower than the operation voltage of the host system 10h, and the second signal has the second voltage equal to the reference potential in a case where the first voltage is higher than the operation voltage of the host system 10h. In a case where the first voltage is higher than the operation voltage of the host system 10h, the information processing apparatus 1 has a circuit configuration that brings the potential of one end of the rectifying element D01 close to the reference potential.

Also, each of the second voltage in a case where the second voltage is higher than the first voltage and the reference potential may be equal to the operation voltage of the peripheral device.

The peripheral device is, for example, the SSD 23s. The first signal may be a sideband signal indicating an operation situation of the peripheral device, and the second signal may be the voltage setting signal vio_cfg indicating the operation voltage of the peripheral device. The sideband signal may be a power loss notification signal PLN #indicating whether or not power loss occurs in the peripheral device.

According to this configuration, in a case where the operation voltage of the peripheral device is applied as the first voltage and the operation voltage of the peripheral device is higher than the operation voltage of the host system 10h, the potential of one end of the rectifying element D01 is lowered. In a case where the peripheral device having an operation voltage higher than the operation voltage of the host system 10h is connected, the input of a signal having a voltage higher than the operation voltage of the host system 10h is avoided. For that reason, it is possible to prevent unintended obstacles of the host system 10h.

The above-described circuit configuration may be characterized in that the second signal terminal is short-circuited to the first signal terminal. With this configuration, the potentials of the first signal terminal and the second signal terminal are the reference potential, and the potential of one end of the rectifying element D01 is also the reference potential. For that reason, even in a case where the operation voltage of the peripheral device that is higher than the operation voltage of the host system 10h is applied to the first signal terminal, the input of the first signal having an operation voltage higher than any other operation voltage to the host system 10h is avoided.

The information processing apparatus 1 may include a power supply circuit (for example, the SSD power supply 23p) that enables the supply of power to the peripheral device in a case where an operation control signal having a voltage higher than the reference potential is input, and a power switch (for example, the power button 38) that outputs an operation instruction signal indicating the necessity of the operation of the information processing apparatus 1 in accordance with whether or not the voltage of the operation control signal is higher than the reference potential. The above-described circuit configuration may further include the logical product circuit AG01 that outputs, to the power supply circuit, the operation control signal having a voltage higher than the reference potential in a case where the voltage of the operation instruction signal and the second voltage are each higher than the reference potential, and having a voltage no significant difference from the reference potential in a case where at least one of the voltage of the operation instruction signal and the second voltage has no significant difference from the reference potential. With this configuration, in a case where a peripheral device having an operation voltage higher than the operation voltage of the host system 10h is connected and the operation of the information processing apparatus 1 is requested by the power switch, the operation control signal having a voltage having no significant difference from the reference potential is input to the power supply circuit from the logical product circuit AG01. In this case, since the power supply circuit does not supply power to the peripheral device, the operation voltage is not applied even in a configuration in which the operation voltage of the peripheral device is applied as the first voltage. For that reason, the input of a signal having a voltage higher than the operation voltage of the host system 10h from one end of the rectifying element D01 is avoided.

Although embodiments of the present invention have been described in detail with reference to the drawings, the specific configurations are not limited to the above-described embodiments, and the present invention includes designs and the like within a scope not departing from the spirit of the invention. It is possible to optionally combine the configurations described in the above-described embodiments.

### DESCRIPTION OF SYMBOLS

1 information processing apparatus
10h host system
11 CPU
12 main memory
21 chipset
22 BIOS memory
23 socket
24 audio system
video system
26 WLAN card
27 USB connector
31 EC
32 input device
33 power supply circuit
38 power button
D01 rectifying element
AG01 logical product circuit

What is claimed is:

1. An information processing apparatus comprising:
a host system;
a rectifying element configured to output a signal input to one end to the other end; and
a socket configured to connect a peripheral device,
wherein the host system is connected to the other end,
the socket includes a first signal terminal to which a first signal is input from the peripheral device and a second signal terminal to which a second signal is input from the peripheral device in a case where the socket is connected to the peripheral device, and the first signal terminal is connected to the one end,
the first signal has a first voltage higher than a reference potential,
the second signal has a second voltage higher than the reference potential in a case where the first voltage is equal to or lower than an operation voltage of the host system, and has a second voltage having no significant difference from the reference potential in a case where the first voltage is higher than the operation voltage of the host system, and
the information processing apparatus further includes a circuit configuration configured to bring a potential of the one end close to the reference potential in a case where the first voltage is higher than the operation voltage of the host system.

2. The information processing apparatus according to claim 1,
wherein, in the circuit configuration, the second signal terminal is short-circuited to the first signal terminal.

3. The information processing apparatus according to claim 1, further comprising:
a power supply circuit configured to supply power to the peripheral device in a case where an operation control signal having a voltage higher than the reference potential is input; and
a power switch configured to output an operation instruction signal indicating necessity of an operation of the information processing apparatus in accordance with whether or not the operation control signal has a voltage higher than the reference potential,
wherein the circuit configuration includes a logical product circuit that outputs, to the power supply circuit, an operation control signal having a voltage higher than the reference potential in a case where a voltage of the operation instruction signal and the second voltage are each higher than the reference potential, and having a voltage having no significant difference from the reference potential in a case where at least one of the voltage of the operation instruction signal and the second voltage has no significant difference from the reference potential.

4. The information processing apparatus according to claim 1,
wherein the peripheral device is a solid state drive.

5. The information processing apparatus according to claim 1,
wherein a second voltage higher than the first voltage and the reference potential are each equal to an operation voltage of the peripheral device.

6. The information processing apparatus according to claim 1,
wherein the first signal is a sideband signal indicating an operation situation of the peripheral device, and
the second signal is a voltage setting signal indicating an operation voltage of the peripheral device.

7. The information processing apparatus according to claim 6,
wherein the sideband signal is a power loss notification signal indicating whether or not power loss of the peripheral device occurs, and
the voltage setting signal indicates whether or not the operation voltage of the peripheral device is equal to the operation voltage of the host system.
